(19) United States
(12) Patent Application Publication
(10) Pub. No.: US 2013/0183392 A1
(43) Pub. Date: Jul. 18, 2013

(54) INSECT REPELLANT AND SYSTEM

(71) Applicants: Steven Moore, Dallas, TX (US); Gerald Marshall, Athens, TX (US); Larry Nouvel, Plano, TX (US)

(72) Inventors: Steven Moore, Dallas, TX (US); Gerald Marshall, Athens, TX (US); Larry Nouvel, Plano, TX (US)

(21) Appl. No.: 13/545,943

(22) Filed: Jul. 10, 2012

Related U.S. Application Data
(60) Provisional application No. 61/508,520, filed on Jul. 15, 2011.

(51) Int. Cl. A01N 65/44; A01N 31/02; A01N 65/28; A01N 65/22; A01N 65/24; A01N 65/06; A01N 65/20; A01N 35/04

(52) U.S. Cl. CPC A01N 65/44; A01N 65/20; A01N 31/02; A01N 35/04; A01N 65/22; A01N 65/24; A01N 65/06; A01N 65/28
USPC 424/739; 424/745

(57) ABSTRACT

The present invention is directed to an insect repellant composition comprising geraniol, thyme oil, vanillin, and a castor oil based emulsifier. The insect repellant composition is mechanically aerially dispersed over a region such that it evaporates during dispersement and from the landing surface. In an alternate embodiment, the insect repellant is applied topically.

### PRIORITY

The present invention claims priority to provisional application 61/508,520, which has a filing date of Jul. 15, 2011, which is hereby incorporated by reference.

### BACKGROUND

1. Field of the Invention

The present invention relates to an insect repellent composition and a system for use thereof.

2. Description of the Related Art

DEET (N,N,diethyl-meta-toluamide) is the active ingredient of many commercial insect repellants. It can be dispersed into the air, typically being mixed with a carrier solvent and evaporated to provide the repellant effect. It can also be applied topically. In various concentrations, it provide its insect repellant effects for several hours. Research indicates that DEET and other repellants are thought to block the olfactory receptors or that insects dislike the smell of DEET. However, DEET suffers from several key disadvantages. It does not occur naturally and requires an involved synthesis. Second, it has known health concerns such as skin irritation, disorientation, and, in extreme cases, seizures or death. Moreover, it is not recommended for application to children. Third, it has an unpleasant odor. Fourth, it acts as a plasticizer and solvent, damaging plastics, synthetic fabrics, and other common materials of its users.

In response, the field has sought to develop and use alternative insect repellants. Additionally, over time, regulatory agencies have developed lists of components which impose minimal health risks in use and are demonstrably safe for the intended use. Various non-DEET insect repellant compositions have been developed using naturally occurring compositions and compositions from various regulatory lists. However, those compositions have been deficient, suffering from weaknesses such as efficacy, duration of efficacy, consistent efficacy during application and use, complicated and involved syntheses, difficulty in dispersion, and limited shelf life. For the above reasons, it would be advantageous to develop an effectual, non-DEET based insect repellant.

### SUMMARY

The present invention is directed to an insect repellant composition selected from the following: geraniol, thyme oil, vanillin, soybean oil, lemon oil, cinnamon oil, rosemary oil, clove oil, cedar oil, a castor oil based emulsifier, a diluent, and a carrier solvent. The insect repellant composition is preferably atomized and mechanically dispersed over a region such that it evaporates during dispersement and from the resting surface. In an alternate embodiment, the insect repellant is applied topically.

These and other features, aspects, and advantages of the invention will become better understood with reference to the following description, and accompanying drawings.

### BRIEF DESCRIPTION OF THE DRAWINGS

FIG. 1 depicts a graph of percent repellancy rates over time of an embodiment of the insect repellant mechanical dispersed from a manual trigger sprayer;

FIG. 2 depicts a graph of percent repellancy rates over time of an embodiment of the insect repellant mechanical dispersed from an All Clear Mister unit; and

FIG. 3 depicts a graph of percent repellancy rates over time of an embodiment of the insect repellant mechanical dispersed from an All Clear Mister Pro unit.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention is directed to a composition, method, and system for repelling insects, specifically, mosquitoes, fruit flies, house flies, no-see-urns, and other insects. The composition includes geraniol, thyme oil, and vanillin. The composition may include soybean oil, lemon oil, cinnamon oil, rosemary oil, clove oil, cedar oil, a castor oil based emulsifier, a diluent, a carrier solvent, a diluent, an emulsifier, a carrier solvent, and a preservative.

Geraniol, as used in this specification, refers to a compound which can be extracted from the geranium plant, among other sources. It's chemical formula is C₁₀H₁₈O or 2,6-Dimethyl-trans-2,6-octadien-8-ol. The geraniol 60 employed in this embodiment is available from Hogan Flavors & Fragrances, Springwell Intl, Intarome, or Eco Smart. It should be appreciated that different geraniol bases can be employed within this invention. Thus geraniol, geraniol 80, or other geraniol formulations can be substituted. In one aspect of this embodiment, the geraniol 60 is present in this formulation at about 2.7% to 16.0%. In another aspect of this embodiment, the geraniol 60 is present in this formulation at about 2.7% to 8.0%. In yet another aspect of this embodiment, the geraniol 60 is present in this formulation at about 2.7% to 3.3%. In yet another aspect of this embodiment, the geraniol 60 is present in this formulation at about 3.0%.

Thyme oil, as used in this specification, refers to the extracts of at least some of the components contained in the herbaceous plant Thymus vulgaris, often referred to as common thyme. The thyme oil can be extracted from the plant by water, steam distillation or other means within the art. The thyme oil can include include one or more of the following chemical components in active proportions: thymol (C₁₀H₁₄O, 2-isopropyl-5-methylphenol), a-thujone (C₁₀H₁₆O, 4-methyl-1-propan-2-ylbicyclo[3.1.0]hexan-3-one), a-pinene (C₁₀H₁₆, (1S,5S)-2,6,6-Trimethyl bicyclo[3.1.1]hept-2-ene ((-)-a-Pinene)), camphene (C₁₀H₁₆, 2,2-dimethyl-3-methylene-bicyclo[2.2.1]heptane), b-pinene (C₁₀H₁₆, 6,6-dimethyl-2-methylenebicyclo [3.1.1] heptane), p-cymene (C₁₀H₁₄, 1-Methyl-4-(1-methylethyl)benzene), a-terpinene (C₁₀H₁₆, 4-methyl-1-(1-methylethyl)-1,3-cyclohexadiene), linalool (C₁₀H₁₈O, 3,7-dimethylocta-1,6-dien-3-ol), borneol (C₁₀H₁₈O, endo-1,7,7-Trimethyl- bicyclo[2.2.1]heptan-2-ol), b-caryophyllene (C₁₅H₂₄, 4,11,11-trimethyl-8-methylene-bicyclo[7.2.0]undec-4-ene), and carvacrol (C₁₀H₁₄O, 5-isopropyl-2-methylphenol). Thyme oil which does not contain all of the the above-referenced chemical components or where the proportions of those chemical components vary is within the spirit of this embodiment. The thyme oil of this embodiment is available from Hogan Flavors & Fragrances, Springwell Intl, Intarome, or EcoSmart. . In one aspect of this embodiment, the thyme oil is present in this formulation at about 2.59% to 16.0%. In another aspect of this embodiment, the thyme oil is present in this formulation at about 2.59% to 8.0%. In yet another aspect of this embodiment, the thyme oil is present in this formulation at about 2.59% to 3.17%. In another aspect of this embodiment, the thyme oil is present in this formulation at about 3.0%.

Vanillin, as used in this specification, refers to the primary component of the extract of the vanilla bean. The vanillin can be extracted from the bean by dissolving into water, blanching, or other means within the art. The vanilla bean extraction may yield compounds in addition to the primary active component vanillin. The chemical formula for vanillin is C₈H₈O₃ and it is also known as 4-hydroxy-3-methoxybenzaldehyde. The vanillin of this embodiment is available from Hogan Flavors & Fragrances, Polarome, or Ungerer & Co. In one aspect of this embodiment, the vanillin is present in this formulation at about 0.10% to 7.0%. In a second aspect of this embodiment, the vanillin is present in this formulation at about 0.1% to 3.5%. In one aspect of this embodiment, the vanillin is present in this formulation at about 0.108% to 0.132%. In another aspect of this embodiment, the vanillin is present in this formulation at about 0.12%.

Lemon grass oil, as used in this specification, refers to extracts of the species of grasses of the cymbopogon genus. The lemon grass oil of this embodiment is available from Hogan Flavors & Fragrances, Springwell Intl, Intarome, or EcoSmart. In one aspect of this embodiment, the lemon grass oil is present in this formulation from about 0.25% to 3.0%. In another aspect of this embodiment, the lemon grass oil is present in this formulation from about 0.8% to 1.5%. In yet another aspect of this embodiment, the lemon grass oil is present in this formulation at about 1.00%.

Cinnamon oil is a concentrated extract taken from the inner bark of several trees from the genus Cinnamomum. The cinnamon oil of this embodiment is available from Hogan Flavors & Fragrances, Springwell Intl, Intarome, or EcoSmart. In one aspect of this embodiment, the cinnamon oil is present in this formulation from about 0.25% to 3.0%. In another aspect of this embodiment, the cinnamon oil is present in this formulation from about 0.8% to 1.5%. In yet another aspect of this embodiment, the cinnamon oil is present in this formulation at about 1.00%.

Rosemary oil, as used in this specification, refers to the extract of the rosemary plant. The rosemary oil of this embodiment is available from Hogan Flavors & Fragrances, Springwell Intl, Intarome, or EcoSmart. In one aspect of this embodiment, the rosemary oil is present in this formulation from about 0.1% to 3.0%. In another aspect of this embodiment, the rosemary oil is present in this formulation from about 0.8% to 1.5%. In yet another aspect of this embodiment, the rosemary oil is present in this formulation at about 1.00%.

Clove oil, as used in this specification, refers to the extract leaves of the clove tree. The clove oil of this embodiment is available from Hogan Flavors & Fragrances. In one aspect of this embodiment, the clove oil is present in this formulation from about 0.25% to 3.0%. In another aspect of this embodiment, the clove oil is present in this formulation from about 0.8% to 1.5%. In yet another aspect of this embodiment, the clove oil is present in this formulation at about 1.00%.

Cedar oil, as used in this specification, is derived from the foliage, wood, or roots of various types of conifers, most in the pine or cypress botanical families. The rosemary oil of this embodiment is available from Hogan Flavors & Fragrances, Springwell Intl, Intarome, or EcoSmart. In one aspect of this embodiment, the cedar oil is present in this formulation at about 0.10% to 0.60%. In another aspect of this embodiment, the cedar oil is present in this formulation at about 0.450% to 0.550%. In yet another aspect of this embodiment, the cedar oil is present in this formulation at about 0.50%.

Soybean oil, as used in this specification, is produced from the extract obtained from seeds of the soybean. In one aspect of this embodiment, the soybean oil is present in this formulation from about 15.0% to 25.0%. In one aspect of this embodiment, the soybean oil is present in this formulation at about 20.00%.

A diluent is included in the composition, primarily in order to reduce the viscosity of the insect repellant. The preferred diluent of this embodiment is water. Alternate diluents which are inactive with respect to the other components and have a suitable viscosity for mechanical dispersement may be used as a diluent. Isopropyl alcohol is one such suitable alternative.

A carrier solvent is included in the composition, whereby the other components of the insect repellant may be included, enabling the insect repellant to be delivered via a mechanical disperser. The preferred carrier solvent of this embodiment is water. Other suitable carrier solvents include those which are inactive with respect to the other components and have a suitable viscosity for mechanical dispersement. Isopropyl alcohol is one such suitable alternative. It is within the spirit of this invention for a single component to act as both a diluent and carrier solvent.

Geraniol and thyme oil have low miscibility with the preferred diluent and carrier solvent water. An emulsifier is included in the insect repellant in order to support the stability of the composition. Suitable emulsifiers are castor oil based derivatives, polyethylene glycol castor oil derivatives and or polyoxyethylene castor oil derivatives. Preferred castor oil based derivatives include refined castor oil, PEG-40 castor oil and PEG-40 hydrogenated castor oil, POE-36 castor oil, or a composite thereof. The PEG-40 Castor Oil of this embodiment is available from Lambent Technologies Corporation, Rita Corporation, or Ethox under the trade name Lumulse CO-40. The castor oil based derivative is preferably present at greater than 5% concentration. In one aspect, the castor oil based derivative is present from about 5% to 25%. In another aspect, the castor oil based derivative is present from about 10% to 18%.

A preservative is optionally included in the insect repellant of the current embodiment in order to inhibit decomposition of the insect repellant. The preferred preservative of the current embodiment is potassium sorbate (C₆H₇KO₂, potassium (2E,4E)-hexa-2,4-dienoate), although other preservatives, such as benzoates, nitrites, sulphites, and other sorbates may be incorporated. Specifically, representative alternate preservatives include sodium benzoate, benzoic acid, sodium nitrite, sulphur dioxide, or sodium sorbate. In one aspect, the preservative is present from about 0.1% to 1.0%.

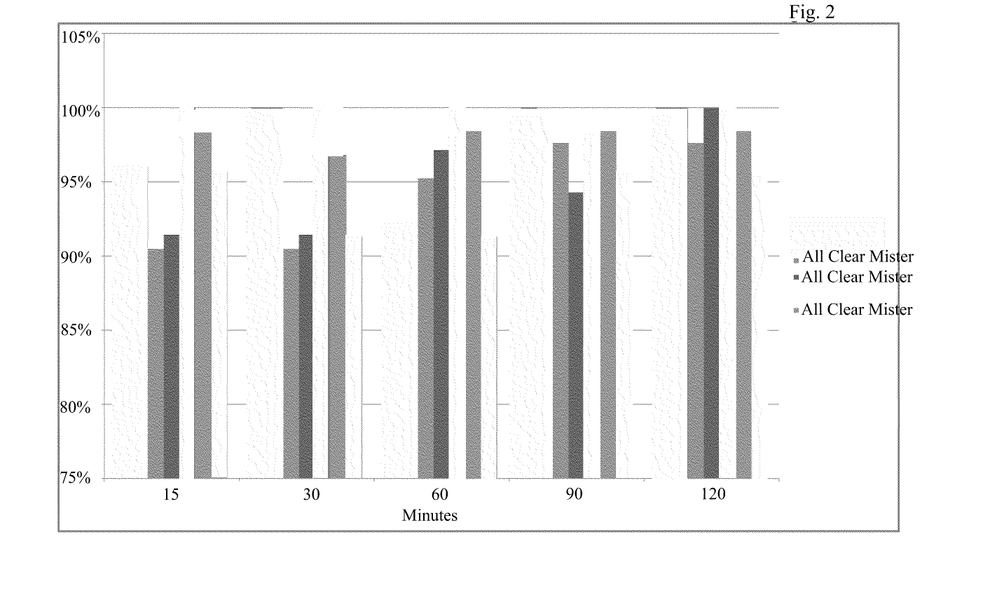

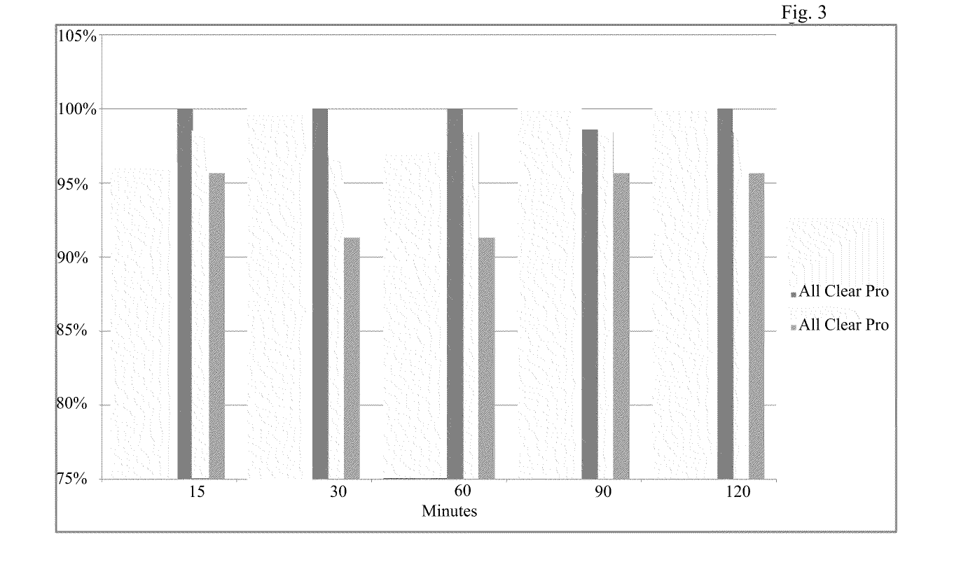

The insect repellant is preferably atomized and dispersed into the air over the desired area with a mechanical disperser to provide the desired repellancy over a region. A portion of the insect repellant evaporates during dispersement and the remainder evaporates from the resting surface. Suitable mechanical dispersers include hand trigger sprayers, portable misting systems, or higher volume misting systems for residential or commercial sized areas. Depending on the employed mechanical dispenser, the dispersement rate, and the insect repellant formulation, the insect repellant can be effective over areas of about 200 square feet to 10,000 square feet. As shown in FIGS. 2-3, the AllClear Mister™ and AllClear Mister Pro™ systems have been used to disperse the insect repellent of this invention.

The geraniol, thyme oil, vanillin, supplemental active ingredients, castor oil based emulsifier, solvent, and carrier are mixed in proportion to yield, among other characteristics, an optimal insect repellancy, evaporation rate, and stability of the emulsion. For example, the proportions of the repellant components are selected such that the insect repellancy is within a desired, substantially constant range for a selected duration. Whereas the compound geraniol and cedar oil tend to have repellancy that rapidly decreases over time when used in isolation and the rosemary oil, thyme oil, and vanillin tend to have delayed repellancy when used in isolation, the proportion of each component is adjusted correspondingly. The proportions should be adjusting for synergistic effects between the components. Whereas a stable emulsion is necessary for storage and dispersement of the composition, the proportion of the miscible layers and emulsifier is adjusted accordingly.

### Example 1

This example describes the preparation of an embodiment of an insect repellant of the current invention. The insect repellant was obtained by mixing the following components:

| Component | Percentage by Weight |
|---|---|
| Geraniol 60 | 3.00 |
| Thyme Oil | 2.88 |
| Vanillin | 0.12 |
| PEG-40 Castor Oil | 10.00 |
| Water | 83.85 |
| Potassium Sorbate | 0.15 |

At room temperature and under normal atmospheric pressure, the liquid geraniol and thyme oils were added to the reaction vessel and mixed together. Vanillin was added and mixed until it was dissolved. Next, the castor oil derivative was added with mixing. In a second reaction vessel, potassium sorbate was added to water with mixing. The contents of the second reaction vessel were added to the contents of the first reaction vessel with mixing. The resulting composition was a milky white, low viscosity liquid.

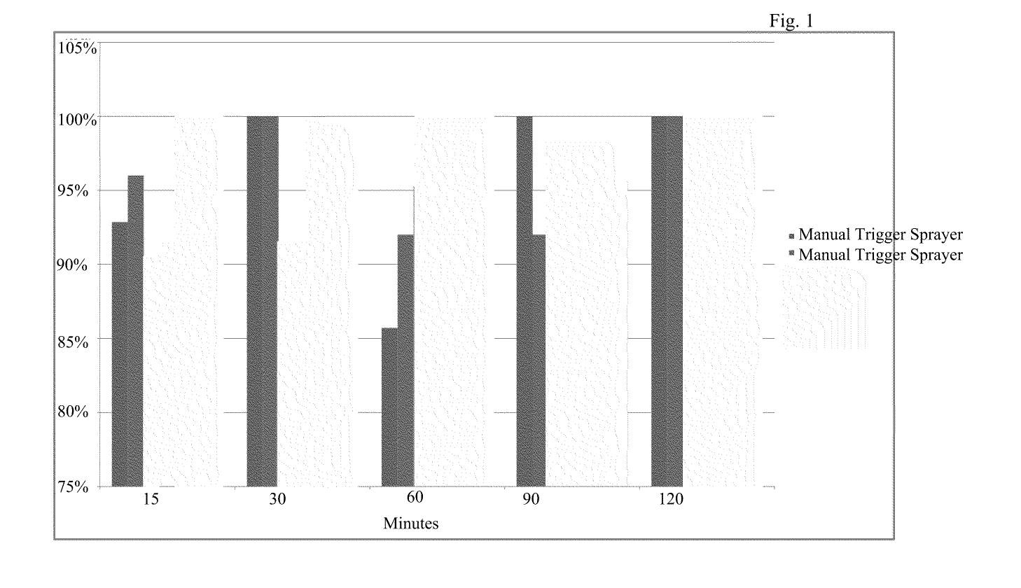

The resulting composition from the reaction vessel was introduced to a manual trigger sprayer, an AllClear Mister, and an AllClear Mister Pro mechanical dispersers and mosquitoes were introduced into a controlled environment. Landing rates were measured over time to determine the percent repellancy. FIGS. 1 through 3 show the result of the testing. The Y axis represents the percent repellancy. The X axis represents the time in minutes at which measurements were taken and calculated.

### Example 2

This example describes the preparation of an embodiment of an insect repellant of the current invention. The insect repellant was obtained by mixing the following components:

| Component | Percentage by Weight |
|---|---|
| Geraniol 60 | 3.00 |
| Thyme Oil | 2.88 |
| Vanillin | 0.12 |
| Castor Oil (refined) | 3.00 |
| POE-36 Castor Oil | 9.00 |
| Water | 81.85 |
| Potassium Sorbate | 0.15 |

At room temperature and under normal atmospheric pressure, the liquid geraniol, thyme oils, and vanillin were added to the reaction vessel and mixed together until the vanillin was dissolved and the solution was clear. Then, the castor oil derivative was added with mixing. In a second reaction vessel, potassium sorbate was added to water with mixing. The contents of the second reaction vessel were added to the contents of the first reaction vessel with mixing. The resulting composition was a milky white, low viscosity liquid.

### Example 3

This example describes the preparation of an embodiment of an insect repellant of the current invention. The insect repellant was obtained by mixing the following components:

| Component | Percentage by Weight |
|---|---|
| Geraniol 60 | 3.00 |
| Thyme Oil | 2.88 |
| Vanillin | 0.12 |
| Castor Oil (refined) | 3.00 |
| POE-40 Castor Oil | 9.00 |
| Water | 81.85 |
| Potassium Sorbate | 0.15 |

### Example 4

This example describes the preparation of an embodiment of an insect repellant of the current invention. The insect repellant was obtained by mixing the following components:

| Component | Percentage by Weight |
|---|---|
| Geraniol 60 | 7.50 |
| Thyme Oil | 7.20 |
| Vanillin | 0.12 |
| Rosemary Oil | 0.50 |
| Cedar Oil | 0.50 |
| Clove Oil | 1.00 |
| Castor Oil (refined) | 3.00 |
| POE-36 Castor | 9.00 |
| Water | 72.18 |

This formulation was diluted with water at a 1 to 1.5 formulation to water ratio prior to use.

### Example 5

This example describes the preparation of an embodiment of an insect repellant of the current invention. The insect repellant was obtained by mixing the following components:

| Component | Percentage by Weight |
|---|---|
| Geraniol | 3.00 |
| Thyme Oil | 2.88 |
| Vanillin | 0.12 |
| Rosemary Oil | 0.20 |
| Cedar Oil | 0.20 |
| POE-36 Castor Oil | 12.00 |
| PEG-40 Castor Oil | 4.50 |
| Castor Oil (refined) | 3.00 |
| Water | 74.10 |

### Example 6

This example describes the preparation of an embodiment of an insect repellant of the current invention. The insect repellant is obtained by mixing the following components:

| Component | Percentage by Weight |
|---|---|
| Geraniol | 7.50 |
| Thyme Oil | 7.20 |
| Vanillin | 0.12 |
| Rosemary Oil | 0.50 |
| Cedar Oil | 0.50 |
| POE-36 Castor Oil | 12.00 |
| PEG-40 Castor Oil | 4.50 |
| Castor Oil (refined) | 3.00 |
| Water | 64.68 |

This formulation is diluted with water at a 1 to 1.5 formulation to water ratio prior to use.

### Example 7

This example describes the preparation of an alternate embodiment of an insect repellant of the current invention for topical application. The insect repellant is obtained by mixing the following components:

| Component | Percentage by Weight |
|---|---|
| Geraniol 60 | 3.00 |
| Thyme Oil | 2.88 |
| Vanillin | 0.12 |
| Water | 93.85 |
| Potassium Sorbate | 0.15 |

At room temperature and under normal atmospheric pressure, the liquid geraniol and thyme oils are added to a reaction vessel and mixed together. Vanillin is added and mixed until it is dissolved. In a second reaction vessel, potassium sorbate is added to water with mixing. The contents of the second reaction vessel are added to the contents of the first reaction vessel with mixing. The resulting composition should be a milky white, low viscosity liquid. The resulting composition from the reaction vessel is applied topically.

### Example 8

This example describes the preparation of an alternate embodiment of an insect repellant of the current invention for topical application. The insect repellant is obtained by mixing the following components:

| Component | Percentage by Weight |
|---|---|
| Geraniol 60 | 3.00 |
| Thyme Oil | 2.88 |
| Vanillin | 0.12 |
| Soybean Oil | 20.00 |
| Isopropyl Alcohol | 73.85 |
| Potassium Sorbate | 0.15 |

### Example 9

This example describes the preparation of an alternate embodiment of an insect repellant of the current invention for topical application. The insect repellant is obtained by mixing the following components:

| Component | Percentage by Weight |
|---|---|
| Geraniol 60 | 3.00 |
| Thyme Oil | 2.88 |
| Vanillin | 0.12 |
| Lemon Grass Oil | 1.00 |
| Cinnamon Oil | 1.00 |
| Rosemary Oil | 1.00 |
| Clove Oil | 1.00 |
| Soybean Oil | 20.00 |
| Isopropyl Alcohol | 70.00 |

Insofar as the description above and the accompanying drawings disclose any additional subject matter, the inventions are not dedicated to the public and the right to file one or more applications to claim such additional inventions is reserved.

What is claimed is:

1. An insect repellant comprising:
geraniol, thyme oil, vanillin, an emulsifier, and a diluent.

2. The insect repellant of claim 1, which comprises about 2.7% to 3.3% by weight geraniol 60, from about 2.59% to 3.17% by weight thyme oil, and from about 0.108% to 0.132% by weight vanillin.

3. The insect repellant of 2, wherein said emulsifier is PEG-40 castor oil.

4. The insect repellant of 3, which comprises about 10% by weight PEG-40 castor oil.

5. The insect repellant of 2, wherein said emulsifier is POE-36 castor oil.

6. The insect repellant of 5, which comprises about 10% by weight POE-36 castor oil.

7. The insect repellant of 2, wherein said emulsifier is a mixture of refined castor oil and POE-36 castor oil.

8. The insect repellant of 7, which comprises about 9% by weight POE-36 castor oil and about 3% by weight refined castor oil.

9. The insect repellant of claim 2, wherein said emulsifier is a mixture of refined castor oil, POE-36 castor oil, and PEG-40 castor oil.

10. The insect repellant of claim 9 which comprises about 3% by weight refined castor oil, about 12% by weight POE-36 castor oil, and about 4.50% by weight PEG-40 castor oil.

11. The insect repellant of 2, further comprising soybean oil and isopropyl alcohol.

12. The insect repellant of 11, which comprises about 20% by weight soybean oil and about 74% by weight isopropyl alcohol.

13. The insect repellant of claim 12 further comprising a preservative.

14. The insect repellant of claim 13 which comprises from about 0.1% to 1.0% by weight potassium sorbate.

15. The insect repellant of 2, further comprising cedar oil and rosemary oil.

16. The insect repellant of 15, which comprises from about 0.1% to 0.6% by weight cedar oil and from about 0.1% to 0.6% by weight rosemary oil.

17. The insect repellant of 2, further comprising lemon grass oil, cinnamon oil, rosemary oil, and clove oil.

18. The insect repellant of 17, which comprises from about 0.25% to 3% by weight lemon grass oil, from about 0.25% to 3% by weight cinnamon oil, from about 0.1% to 3% by weight rosemary oil, and from about 0.25% to 3% by weight clove oil.

19. The insect repellant of 17, further comprising soybean oil and isopropyl alcohol.

20. The insect repellant of 19, which comprises about 20% by weight soybean oil and about 70% by weight isopropyl alcohol.

21. The insect repellant of 2, which comprises about 3.0% by weight to geraniol 60, about 2.88% by weight thyme oil, and about 0.12% by weight vanillin.

22. The insect repellant of 21, which further comprises about 3% by weight POE-36 castor oil, about 9% by weight refined castor oil, and about 81.85% water.

23. The insect repellant of claim 22, further comprising comprises from about 0.1% to 1.0% by weight potassium sorbate.

24. The insect repellant of 21, which further comprises about 20% by weight soybean oil and about 73.75% by weight isopropyl alcohol.

25. The insect repellant of claim 24 further comprising comprises from about 0.1% to 1.0% by weight potassium sorbate.

26. The insect repellant of 21, which further comprises from about 0.25% to 3% by weight lemon grass oil, from about 0.25% to 3% by weight cinnamon oil, from about 0.1% to 3% by weight rosemary oil, and from about 0.25% to 3% by weight clove oil, about 20% by weight soybean oil, and about 70% by weight isopropyl alcohol.

27. The insect repellant of claim 1, which comprises about 2.7% to 8.0% by weight geraniol 60, from about 2.59% to 8.0% by weight thyme oil, and from about 0.10% to 0.13% by weight vanillin.

28. The insect repellant of 27, wherein said emulsifier is PEG-40 castor oil.

29. The insect repellant of 28, which comprises about 10% by weight PEG-40 castor oil.

30. The insect repellant of 27, wherein said emulsifier is POE-36 castor oil.

31. The insect repellant of 30, which comprises about 10% by weight POE-36 castor oil.

32. The insect repellant of 27, wherein said emulsifier is a mixture of refined castor oil and POE-36 castor oil.

33. The insect repellant of 32, which comprises about 9% by weight POE-36 castor oil and about 3% by weight refined castor oil.

34. The insect repellant of claim 27, wherein said emulsifier is a mixture of refined castor oil, POE-36 castor oil, and PEG-40 castor oil.

35. The insect repellant of claim 34 which comprises about 3% by weight refined castor oil, about 12% by weight POE-36 castor oil, and about 4.50% by weight PEG-40 castor oil.

36. The insect repellant of 27, further comprising soybean oil and isopropyl alcohol.

37. The insect repellant of 36, which comprises about 20% by weight soybean oil and about 74% by weight isopropyl alcohol.

38. The insect repellant of claim 37 further comprising a preservative.

39. The insect repellant of claim 38 which comprises comprises from about 0.1% to 1.0% by weight potassium sorbate.

40. The insect repellant of 27, further comprising cedar oil and rosemary oil.

41. The insect repellant of 40, which comprises from about 0.1% to 0.6% by weight cedar oil and from about 0.1% to 0.6% by weight rosemary oil.

42. The insect repellant of 27, further comprising lemon grass oil, cinnamon oil, rosemary oil, and clove oil.

43. The insect repellant of 42, which comprises from about 0.25% to 3% by weight lemon grass oil, from about 0.25% to 3% by weight cinnamon oil, from about 0.1% to 3% by weight rosemary oil, and from about 0.25% to 3% by weight clove oil.

44. The insect repellant of 41, further comprising soybean oil and isopropyl alcohol.

45. The insect repellant of 44, which comprises about 20% by weight soybean oil and about 70% by weight isopropyl alcohol.

46. The insect repellant of 27, which comprises about 7.5% by weight geraniol 60, about 7.20% by weight thyme oil, and about 0.12% by weight vanillin.

47. The insect repellant of 46, which further comprises about 3% by weight POE-36 castor oil, about 9% by weight refined castor oil, and about 81.85% water.

48. The insect repellant of claim 47, further comprising comprises from about 0.1% to 1.0% by weight potassium sorbate.

49. The insect repellant of 46, which further comprises about 20% by weight soybean oil and about 73.75% by weight isopropyl alcohol.

50. The insect repellant of claim 49 further comprising comprises from about 0.1% to 1.0% by weight potassium sorbate.

51. The insect repellant of 46, which further comprises from about 0.25% to 3% by weight lemon grass oil, from about 0.25% to 3% by weight cinnamon oil, from about 0.1% to 3% by weight rosemary oil, and from about 0.25% to 3% by weight clove oil, about 20% by weight soybean oil, and about 70% by weight isopropyl alcohol.

52. The insect repellant of claim 1, which comprises about 2.7% to 16.0% by weight to geraniol 60, from about 2.59% to 15.5% by weight thyme oil, and from about 0.108% to 0.132% by weight vanillin.

53. The insect repellant of 52, wherein said emulsifier is PEG-40 castor oil.

54. The insect repellant of 53, which comprises about 10% by weight PEG-40 castor oil.

55. The insect repellant of 52, wherein said emulsifier is POE-36 castor oil.

56. The insect repellant of 55, which comprises about 10% by weight POE-36 castor oil.

57. The insect repellant of 52, wherein said emulsifier is a mixture of refined castor oil and POE-36 castor oil.

58. The insect repellant of 57, which comprises about 9% by weight POE-36 castor oil and about 3% by weight refined castor oil.

59. The insect repellant of claim 52, wherein said emulsifier is a mixture of refined castor oil, POE-36 castor oil, and PEG-40 castor oil.

60. The insect repellant of claim 59 which comprises about 3% by weight refined castor oil, about 12% by weight POE-36 castor oil, and about 4.50% by weight PEG-40 castor oil.

61. The insect repellant of 52, further comprising soybean oil and isopropyl alcohol.

62. The insect repellant of 61, which comprises about 20% by weight soybean oil and about 74% by weight isopropyl alcohol.

63. The insect repellant of claim 62 further comprising a preservative.

64. The insect repellant of claim 63 which comprises comprises from about 0.1% to 1.0% by weight potassium sorbate.

65. The insect repellant of 52, further comprising cedar oil and rosemary oil.

66. The insect repellant of 65, which comprises from about 0.1% to 0.6% by weight cedar oil and from about 0.1% to 0.6% by weight rosemary oil.

67. The insect repellant of 52, further comprising lemon grass oil, cinnamon oil, rosemary oil, and clove oil.

68. The insect repellant of 67, which comprises from about 0.25% to 3% by weight lemon grass oil, from about 0.25% to 3% by weight cinnamon oil, from about 0.1% to 3% by weight rosemary oil, and from about 0.25% to 3% by weight clove oil.

69. The insect repellant of 67, further comprising soybean oil and isopropyl alcohol.

70. The insect repellant of 69, which comprises about 20% by weight soybean oil and about 70% by weight isopropyl alcohol.

71. The insect repellant of 52, which comprises about 15.0% by weight to geraniol 60, about 14.4% by weight thyme oil, and about 0.12% by weight vanillin.

72. The insect repellant of 71, which further comprises about 3% by weight POE-36 castor oil, about 9% by weight refined castor oil, and water.

73. The insect repellant of claim 72, further comprising comprises from about 0.1% to 1.0% by weight potassium sorbate.

74. The insect repellant of 71, which further comprises about 20% by weight soybean oil and about isopropyl alcohol.

75. The insect repellant of claim 74 further comprising comprises from about 0.1% to 1.0% by weight potassium sorbate.

76. The insect repellant of 71, which further comprises from about 0.25% to 3% by weight lemon grass oil, from about 0.25% to 3% by weight cinnamon oil, from about 0.1% to 3% by weight rosemary oil, and from about 0.25% to 3% by weight clove oil, about 20% by weight soybean oil, and about 70% by weight isopropyl alcohol.

77. A system for repelling insects comprising:
a mechanical disperser configured to atomize and disperse an insect repellant;
an insect repellant which comprises geraniol, thyme oil, vanillin.

78. The system of claim 77 wherein said insect repellant comprises from about 2.7% to 16.0% by weight to geraniol 60, from about 2.59% to 15.5% by weight thyme oil, and from about 0.108% to 0.132% by weight vanillin.

79. The system of claim 77 wherein said insect repellant comprises from about 2.7% to 8.0% by weight geraniol 60, from about 2.59% to 8.0% by weight thyme oil, and from about 0.10% to 0.13% by weight vanillin.

80. The system of claim 77 wherein said insect repellant comprises from about 2.7% to 3.3% by weight to geraniol 60, from about 2.59% to 3.17% by weight thyme oil, and from about 0.108% to 0.132% by weight vanillin.

81. The system of claim 78 wherein said insect repellant further comprises about 3% by weight refined castor oil, about 9% by weight POE-36 castor oil, and water.

82. The system of claim 78 wherein said insect repellant further comprises about 10% by weight PEG-40 castor oil and water.

83. The system of claim 78 wherein said insect repellant further comprises about 3% by weight refined castor oil, about 12% by weight POE-36 castor oil, about 4.50% by weight PEG-40 castor oil, and water.

84. The system of claim 77 wherein said disperser is configured to disperse said insect repellant at a particle size of about 0.1 to 0.6 microns.

85. The system of claim 77 wherein said disperser is configured to disperse said insect repellant at a particle size of about 0.29 microns.
